(19) United States
(12) Patent Application Publication
(10) Pub. No.: US 2008/0303006 A1
(43) Pub. Date: Dec. 11, 2008

(54) FLAME RETARDANT THERMOPLASTIC RESINOUS COMPOSTION

(76) Inventors: Frank Huijs, Breda (NL); Dominique Arnould, Breda (NL)

Correspondence Address: SABIC- ESR;SABIC Innovative Plastics - IP Legal, ONE PLASTICS AVENUE, PITTSFIELD, MA, 01201-3697, US

(21) Appl. No.: 11/760,323

(22) Filed: Jun. 8, 2007

(51) Int. Cl. C09K 21/10

(52) U.S. Cl. 252/609

(57) ABSTRACT

Disclosed are compositions comprising: a flame retardant composition comprising (i) an acrylonitrile-styrene-acrylate graft copolymer (ASA) or acrylate-modified ASA, (ii) at least one rigid thermoplastic polymer comprising structural units derived from styrene and acrylonitrile; alpha-methylstyrene and acrylonitrile; alpha-methylstyrene, styrene, and acrylonitrile; styrene, acrylonitrile, and methyl methacrylate; alpha-methyl styrene, acrylonitrile, and methyl methacrylate; or alpha-methylstyrene, styrene, acrylonitrile, and methyl methacrylate, or mixtures thereof, (iii) at least one halogenated flame retardant, (iv) at least one antidrip additive, (v) optionally at least one additive which comprises an inorganic or organic antimony compound, and (vi) optionally at least one acid scavenger. Articles made from said compositions are also disclosed.

### BACKGROUND

The present invention relates to flame retardant thermoplastic resinous compositions which exhibit improved flow properties in the melt while retaining impact strength in molded articles. In particular embodiments the invention relates to rubber modified thermoplastic resinous compositions comprising a halogenated flame retardant.

A common problem in thermoplastic resinous compositions is the need for high flow in the melt to facilitate applications such as injection molding. It is known that lowering the molecular weight of one or more resinous components of a thermoplastic composition typically results in a desired increase in flow. However, it is commonly observed that when the molecular weight of one or more resinous components is lowered, then mechanical properties such as impact strength in molded articles of the composition typically decrease to unacceptable levels. For example, U.S. Pat. No. 6,403,723 teaches resinous compositions comprising an acrylonitrile-styrene-acrylate graft copolymer (ASA) and styrene-acrylonitrile copolymer (SAN). These compositions show increased flow in the melt but have unacceptably decreased impact strength in molded articles as the intrinsic viscosity, and hence the molecular weight, of the SAN component in the composition decreases. U.S. Pat. No. 5,916,936 teaches flame retardant thermoplastic resinous compositions. However, the compositions of this patent require as an essential component a basic inorganic compound which is soluble in a solvent. There exists a need for flame retardant thermoplastic resinous compositions which exhibit high flow in the melt while retaining mechanical properties such as impact strength in molded articles. In particular there exists a need for flame retardant ASA compositions which exhibit high flow in the melt while retaining mechanical properties such as impact strength in molded articles.

### BRIEF DESCRIPTION

The present inventors have discovered novel compositions which exhibit high flow in the melt while retaining mechanical properties such as impact strength in molded articles. In one embodiment the present invention comprises a flame retardant composition comprising (i) 20-65 wt. % of an acrylonitrile-styrene-acrylate graft copolymer (ASA) or acrylate-modified ASA, (ii) 25-45 wt. % of at least one rigid thermoplastic polymer comprising structural units derived from styrene and acrylonitrile; alpha-methylstyrene and acrylonitrile; alpha-methylstyrene, styrene, and acrylonitrile; styrene, acrylonitrile, and methyl methacrylate; alpha-methyl styrene, acrylonitrile, and methyl methacrylate; or alpha-methylstyrene, styrene, acrylonitrile, and methyl methacrylate, or mixtures thereof, (iii) 7-30 wt. % of at least one halogenated flame retardant, (iv) 0.01-2 wt. % of at least one antidrip additive, (v) 0-15 wt. % of at least one additive which comprises an inorganic or organic antimony compound, and (vi) 0-5 wt. % of at least one acid scavenger, wherein wt. % values are based on the weight of components (i)-(vi). In still other embodiments the present invention comprises articles made from said compositions. Various other features, aspects, and advantages of the present invention will become more apparent with reference to the following description and appended claims.

### DETAILED DESCRIPTION

In the following specification and the claims which follow, reference will be made to a number of terms which shall be defined to have the following meanings. The singular forms “a”, “an” and “the” include plural referents unless the context clearly dictates otherwise. The terminology “monoethylenically unsaturated” means having a single site of ethylenic unsaturation per molecule. The terminology “polyethylenically unsaturated” means having two or more sites of ethylenic unsaturation per molecule. The terminology “(meth)acrylate” refers collectively to acrylate and methacrylate; for example, the term “(meth)acrylate monomers” refers collectively to acrylate monomers and methacrylate monomers. The term “(meth)acrylamide” refers collectively to acrylamides and methacrylamides.

The term “alkyl” as used in the various embodiments of the present invention is intended to designate linear alkyl, branched alkyl, aralkyl, cycloalkyl, bicycloalkyl, tricycloalkyl and polycycloalkyl radicals containing carbon and hydrogen atoms, and optionally containing atoms in addition to carbon and hydrogen, for example atoms selected from Groups 15, 16 and 17 of the Periodic Table. Alkyl groups may be saturated or unsaturated, and may comprise, for example, vinyl or allyl. The term “alkyl” also encompasses that alkyl portion of alkoxide groups. In various embodiments normal and branched alkyl radicals are those containing from 1 to about 32 carbon atoms, and include as illustrative non-limiting examples C₁-C₃₂ alkyl (optionally substituted with one or more groups selected from C₁-C₃₂ alkyl, C₃-C₁₅ cycloalkyl or aryl); and C₃-C₁₅ cycloalkyl optionally substituted with one or more groups selected from C₁-C₃₂ alkyl. Some particular illustrative examples comprise methyl, ethyl, n-propyl, isopropyl, n-butyl, sec-butyl, tertiary-butyl, pentyl, neopentyl, hexyl, heptyl, octyl, nonyl, decyl, undecyl and dodecyl. Some illustrative non-limiting examples of cycloalkyl and bicycloalkyl radicals include cyclobutyl, cyclopentyl, cyclohexyl, methylcyclohexyl, cycloheptyl, bicycloheptyl and adamantyl. In various embodiments aralkyl radicals are those containing from 7 to about 14 carbon atoms; these include, but are not limited to, benzyl, phenylbutyl, phenylpropyl, and phenylethyl. The term “aryl” as used in the various embodiments of the present invention is intended to designate substituted or unsubstituted aryl radicals containing from 6 to 20 ring carbon atoms. Some illustrative non-limiting examples of these aryl radicals include C₆-C₂₀ aryl optionally substituted with one or more groups selected from C₁-C₃₂ alkyl, C₃-C₁₅ cycloalkyl, aryl, and functional groups comprising atoms selected from Groups 15, 16 and 17 of the Periodic Table. Some particular illustrative examples of aryl radicals comprise substituted or unsubstituted phenyl, biphenyl, tolyl, naphthyl and binaphthyl.

Compositions of the present invention comprise a rubber modified thermoplastic resin comprising a discontinuous elastomeric phase dispersed in a rigid thermoplastic phase, wherein at least a portion of the rigid thermoplastic phase is grafted to the elastomeric phase. The rubber modified thermoplastic resin employs at least one rubber substrate for grafting. The rubber substrate comprises the discontinuous elastomeric phase of the composition. There is no particular limitation on the rubber substrate provided it is susceptible to grafting by at least a portion of a graftable monomer. In some embodiments suitable rubber substrates comprise dimethyl siloxane/butyl acrylate rubber, or silicone/butyl acrylate composite rubber; polyolefin rubbers such as ethylene-propylene rubber or ethylene-propylene-diene (EPDM) rubber; or silicone rubber polymers such as polymethylsiloxane rubber. The rubber substrate typically has a glass transition temperature, Tg, in one embodiment less than or equal to 25° C., in another embodiment below about 0° C., in another embodiment below about minus 20° C., and in still another embodiment below about minus 30° C. As referred to herein, the Tg of a polymer is the T value of polymer as measured by differential scanning calorimetry (DSC; heating rate 20° C./minute, with the Tg value being determined at the inflection point).

In one embodiment the rubber substrate is derived from polymerization by known methods of at least one monoethylenically unsaturated alkyl (meth)acrylate monomer selected from (C₁-C₁₂)alkyl(meth)acrylate monomers and mixtures comprising at least one of said monomers. As used herein, the terminology “(Cₓ-C_{y})”, as applied to a particular unit, such as, for example, a chemical compound or a chemical substituent group, means having a carbon atom content of from “x” carbon atoms to “y” carbon atoms per such unit. For example, “(C₁-C₁₂)alkyl” means a straight chain, branched or cyclic alkyl substituent group having from 1 to 12 carbon atoms per group. Suitable (C₁-C₁₂)alkyl(meth)acrylate monomers include, but are not limited to, (C₁-C₁₂)alkyl acrylate monomers, illustrative examples of which comprise ethyl acrylate, butyl acrylate, iso-pentyl acrylate, n-hexyl acrylate, and 2-ethyl hexyl acrylate; and their (C₁-C₁₂)alkyl methacrylate analogs, illustrative examples of which comprise methyl methacrylate, ethyl methacrylate, propyl methacrylate, iso-propyl methacrylate, butyl methacrylate, hexyl methacrylate, and decyl methacrylate. In a particular embodiment of the present invention the rubber substrate comprises structural units derived from n-butyl acrylate.

In various embodiments the rubber substrate may also optionally comprise a minor amount, for example up to about 5 wt. %, of structural units derived from at least one polyethylenically unsaturated monomer, for example those that are copolymerizable with a monomer used to prepare the rubber substrate. A polyethylenically unsaturated monomer is often employed to provide cross-linking of the rubber particles and/or to provide “graftlinking” sites in the rubber substrate for subsequent reaction with grafting monomers. Suitable polyethylenically unsaturated monomers include, but are not limited to, butylene diacrylate, divinyl benzene, butene diol dimethacrylate, trimethylolpropane tri(meth)acrylate, allyl methacrylate, diallyl methacrylate, diallyl maleate, diallyl fumarate, diallyl phthalate, triallyl methacrylate, triallyl cyanurate, triallyl isocyanurate, the acrylate of tricyclodecenylalcohol and mixtures comprising at least one of such monomers. In a particular embodiment the rubber substrate comprises structural units derived from triallyl cyanurate.

In some embodiments the rubber substrate may optionally comprise structural units derived from minor amounts of other unsaturated monomers, for example those that are copolymerizable with a monomer used to prepare the rubber substrate. In particular embodiments the rubber substrate may optionally include up to about 25 wt. % of structural units derived from one or more monomers selected from (meth)acrylate monomers, alkenyl aromatic monomers and monoethylenically unsaturated nitrile monomers. Suitable copolymerizable (meth)acrylate monomers include, but are not limited to, C₁-C₁₂ aryl or haloaryl substituted acrylate, C₁-C₁₂ aryl or haloaryl substituted methacrylate, or mixtures thereof, monoethylenically unsaturated carboxylic acids, such as, for example, acrylic acid, methacrylic acid and itaconic acid; glycidyl (meth)acrylate, hydroxy alkyl (meth)acrylate, hydroxy(C₁-C₁₂)alkyl (meth)acrylate, such as, for example, hydroxyethyl methacrylate; (C₄-C₁₂)cycloalkyl (meth)acrylate monomers, such as, for example, cyclohexyl methacrylate; (meth)acrylamide monomers, such as, for example, acrylamide, methacrylamide and N-substituted-acrylamide or N-substituted-methacrylamides; maleimide monomers, such as, for example, maleimide, N-alkyl maleimides, N-aryl maleimides, N-phenyl maleimide, and haloaryl substituted maleimides; maleic anhydride; methyl vinyl ether, ethyl vinyl ether, and vinyl esters, such as, for example, vinyl acetate and vinyl propionate. Suitable alkenyl aromatic monomers include, but are not limited to, vinyl aromatic monomers, such as, for example, styrene and substituted styrenes having one or more alkyl, alkoxy, hydroxy or halo substituent groups attached to the aromatic ring, including, but not limited to, alpha-methyl styrene, p-methyl styrene, 3,5-diethylstyrene, 4-n-propylstyrene, 4-isopropylstyrene, vinyl toluene, alpha-methyl vinyl toluene, vinyl xylene, trimethyl styrene, butyl styrene, t-butyl styrene, chlorostyrene, alpha-chlorostyrene, dichlorostyrene, tetrachlorostyrene, bromostyrene, alpha-bromostyrene, dibromostyrene, p-hydroxystyrene, p-acetoxystyrene, methoxystyrene and vinyl- substituted condensed aromatic ring structures, such as, for example, vinyl naphthalene, vinyl anthracene, as well as mixtures of vinyl aromatic monomers and monoethylenically unsaturated nitrile monomers such as, for example, acrylonitrile, ethacrylonitrile, methacrylonitrile, alpha-bromoacrylonitrile and alpha-chloro acrylonitrile. Substituted styrenes with mixtures of substituents on the aromatic ring are also suitable. As used herein, the term “monoethylenically unsaturated nitrile monomer” means an acyclic compound that includes a single nitrile group and a single site of ethylenic unsaturation per molecule and includes, but is not limited to, acrylonitrile, methacrylonitrile, alpha-chloro acrylonitrile, and the like.

In a particular embodiment the rubber substrate comprises repeating units derived from one or more (C₁-C₁₂)alkyl acrylate monomers. In still another particular embodiment, the rubber substrate comprises from 40 to 95 wt. % repeating units derived from one or more (C₁-C₁₂)alkyl acrylate monomers, and more particularly from one or more monomers selected from ethyl acrylate, butyl acrylate and n-hexyl acrylate.

The rubber substrate may be present in the rubber modified thermoplastic resin in one embodiment at a level of from about 4 wt. % to about 94 wt. %; in another embodiment at a level of from about 10 wt. % to about 80 wt. %; in another embodiment at a level of from about 15 wt. % to about 80 wt. %; in another embodiment at a level of from about 35 wt. % to about 80 wt. %; in another embodiment at a level of from about 40 wt. % to about 80 wt. %; in another embodiment at a level of from about 25 wt. % to about 60 wt. %, and in still another embodiment at a level of from about 40 wt. % to about 50 wt. %, based on the weight of the rubber modified thermoplastic resin. In other embodiments the rubber substrate may be present in the rubber modified thermoplastic resin at a level of from about 5 wt. % to about 50 wt. %; at a level of from about 8 wt. % to about 40 wt. %; or at a level of from about 10 wt. % to about 30 wt. %, based on the weight of the particular rubber modified thermoplastic resin.

There is no particular limitation on the particle size distribution of the rubber substrate (sometimes referred to hereinafter as initial rubber substrate to distinguish it from the rubber substrate following grafting). In some embodiments the initial rubber substrate may possess a broad, essentially monomodal, particle size distribution with particles ranging in size from about 50 nanometers (nm) to about 1000 nm. In other embodiments the mean particle size of the initial rubber substrate may be less than about 100 nm. In still other embodiments the mean particle size of the initial rubber substrate may be in a range of between about 80 nm and about 400 nm. In other embodiments the mean particle size of the initial rubber substrate may be greater than about 400 nm. In still other embodiments the mean particle size of the initial rubber substrate may be in a range of between about 400 nm and about 750 nm. In still other embodiments the initial rubber substrate comprises particles which are a mixture of particle sizes with at least two mean particle size distributions. In a particular embodiment the initial rubber substrate comprises a mixture of particle sizes with each mean particle size distribution in a range of between about 80 nm and about 750 nm. In another particular embodiment the initial rubber substrate comprises a mixture of particle sizes, one with a mean particle size distribution in a range of between about 80 nm and about 400 nm; and one with a broad and essentially monomodal mean particle size distribution.

The rubber substrate may be made according to known methods, such as, but not limited to, a bulk, solution, or emulsion process. In one non-limiting embodiment the rubber substrate is made by aqueous emulsion polymerization in the presence of a free radical initiator, e.g., an azonitrile initiator, an organic peroxide initiator, a persulfate initiator or a redox initiator system, and, optionally, in the presence of a chain transfer agent, e.g., an alkyl mercaptan, to form particles of rubber substrate.

The rigid thermoplastic resin phase of the rubber modified thermoplastic resin comprises one or more thermoplastic polymers. In one embodiment of the present invention monomers are polymerized in the presence of the rubber substrate to thereby form a rigid thermoplastic phase, at least a portion of which is chemically grafted to the elastomeric phase. The portion of the rigid thermoplastic phase chemically grafted to rubber substrate is sometimes referred to hereinafter as grafted copolymer. The rigid thermoplastic phase comprises a thermoplastic polymer or copolymer that exhibits a glass transition temperature (Tg) in one embodiment of greater than about 25° C., in another embodiment of greater than or equal to 90° C., and in still another embodiment of greater than or equal to 100° C.

In a particular embodiment the rigid thermoplastic phase comprises a polymer having structural units derived from one or more monomers selected from the group consisting of (C₁-C₁₂)alkyl-(meth)acrylate monomers, aryl-(meth)acrylate monomers, alkenyl aromatic monomers and monoethylenically unsaturated nitrile monomers. Suitable (C₁-C₁₂)alkyl-(meth)acrylate and aryl-(meth)acrylate monomers, alkenyl aromatic monomers and monoethylenically unsaturated nitrile monomers include those set forth hereinabove in the description of the rubber substrate. In addition, the rigid thermoplastic resin phase may, provided that the Tg limitation for the phase is satisfied, optionally include up to about 10 wt. % of third repeating units derived from one or more other copolymerizable monomers.

The rigid thermoplastic phase typically comprises one or more alkenyl aromatic polymers. Suitable alkenyl aromatic polymers comprise at least about 20 wt. % structural units derived from one or more alkenyl aromatic monomers. In one embodiment the rigid thermoplastic phase comprises an alkenyl aromatic polymer having structural units derived from one or more alkenyl aromatic monomers and from one or more monoethylenically unsaturated nitrile monomers. Examples of such alkenyl aromatic polymers include, but are not limited to, styrene/acrylonitrile copolymers, alpha-methylstyrene/acrylonitrile copolymers, or alpha-methylstyrene/styrene/acrylonitrile copolymers. In another particular embodiment the rigid thermoplastic phase comprises an alkenyl aromatic polymer having structural units derived from one or more alkenyl aromatic monomers; from one or more monoethylenically unsaturated nitrile monomers; and from one or more monomers selected from the group consisting of (C₁-C₁₂)alkyl- and aryl-(meth)acrylate monomers. Examples of such alkenyl aromatic polymers include, but are not limited to, styrene/acrylonitrile/methyl methacrylate copolymers, alpha-methylstyrene/acrylonitrile/methyl methacrylate copolymers and alpha-methylstyrene/styrene/acrylonitrile/methyl methacrylate copolymers. Further examples of suitable alkenyl aromatic polymers comprise styrene/methyl methacrylate copolymers, styrene/maleic anhydride copolymers; styrene/acrylonitrile/maleic anhydride copolymers, and styrene/acrylonitrile/acrylic acid copolymers. These copolymers may be used for the rigid thermoplastic phase either individually or as mixtures.

When structural units in copolymers are derived from one or more monoethylenically unsaturated nitrile monomers, then the amount of nitrile monomer added to form the copolymer comprising the grafted copolymer and the rigid thermoplastic phase may be in one embodiment in a range of between about 5 wt. % and about 40 wt. %, in another embodiment in a range of between about 5 wt. % and about 30 wt. %, in another embodiment in a range of between about 10 wt. % and about 30 wt. %, and in yet another embodiment in a range of between about 15 wt. % and about 30 wt. %, based on the total weight of monomers added to form the copolymer comprising the grafted copolymer and the rigid thermoplastic phase.

When structural units in copolymers are derived from one or more (C₁-C₁₂)alkyl- and aryl-(meth)acrylate monomers, then the amount of the said monomer added to form the copolymer comprising the grafted copolymer and the rigid thermoplastic phase may be in one embodiment in a range of between about 5 wt. % and about 50 wt. %, in another embodiment in a range of between about 5 wt. % and about 45 wt. %, in another embodiment in a range of between about 10 wt. % and about 35 wt. %, and in yet another embodiment in a range of between about 15 wt. % and about 35 wt. %, based on the total weight of monomers added to form the copolymer comprising the grafted copolymer and the rigid thermoplastic phase.

The amount of grafting that takes place between the rubber substrate and monomers comprising the rigid thermoplastic phase varies with the relative amount and composition of the rubber phase. In one embodiment, greater than about 10 wt. % of the rigid thermoplastic phase is chemically grafted to the rubber substrate, based on the total amount of rigid thermoplastic phase in the composition. In another embodiment, greater than about 15 wt. % of the rigid thermoplastic phase is chemically grafted to the rubber substrate, based on the total amount of rigid thermoplastic phase in the composition. In still another embodiment, greater than about 20 wt. % of the rigid thermoplastic phase is chemically grafted to the rubber substrate, based on the total amount of rigid thermoplastic phase in the composition. In particular embodiments the amount of rigid thermoplastic phase chemically grafted to the rubber substrate may be in a range of between about 5 wt. % and about 90 wt. %; between about 10 wt. % and about 90 wt. %; between about 15 wt. % and about 85 wt. %; between about 15 wt. % and about 50 wt. %; or between about 20 wt. % and about 50 wt. %, based on the total amount of rigid thermoplastic phase in the composition. In yet other embodiments, about 40 wt. % to 90 wt. % of the rigid thermoplastic phase is free, that is, non-grafted.

The rigid thermoplastic phase may be present in the rubber modified thermoplastic resin in one embodiment at a level of from about 85 wt. % to about 6 wt. %; in another embodiment at a level of from about 65 wt. % to about 6 wt. %; in another embodiment at a level of from about 60 wt. % to about 20 wt. %; in another embodiment at a level of from about 75 wt. % to about 40 wt. %, and in still another embodiment at a level of from about 60 wt. % to about 50 wt. %, based on the weight of the rubber modified thermoplastic resin. In other embodiments the rigid thermoplastic phase may be present in a range of between about 90 wt. % and about 30 wt. %, based on the weight of the rubber modified thermoplastic resin.

In one embodiment two or more different rubber substrates, each possessing a different mean particle size, may be separately employed in a polymerization reaction to prepare rigid thermoplastic phase, and then the products blended together to make the rubber modified thermoplastic resin. In illustrative embodiments wherein such products each possessing a different mean particle size of initial rubber substrate are blended together, then the ratios of said substrates may be in a range of about 90:10 to about 10:90, or in a range of about 80:20 to about 20:80, or in a range of about 70:30 to about 30:70. In some embodiments an initial rubber substrate with smaller particle size is the major component in such a blend containing more than one particle size of initial rubber substrate.

The rigid thermoplastic phase may be made according to known processes, for example, mass polymerization, emulsion polymerization, suspension polymerization or combinations thereof, wherein at least a portion of the rigid thermoplastic phase is chemically bonded, i.e., “grafted” to the rubber phase via reaction with unsaturated sites present in the rubber phase. The grafting reaction may be performed in a batch, continuous or semi-continuous process. Representative procedures include, but are not limited to, those taught in U.S. Pat. No. 3,944,63 1. The unsaturated sites in the rubber phase are provided, for example, by residual unsaturated sites in those structural units of the rubber that were derived from a graftlinking monomer. In some embodiments of the present invention monomer grafting to rubber substrate with concomitant formation of rigid thermoplastic phase may optionally be performed in stages wherein at least one first monomer is grafted to rubber substrate followed by at least one second monomer different from said first monomer. Representative procedures for staged monomer grafting to rubber substrate include, but are not limited to, those taught in commonly assigned U.S. Pat. No. 7,049,368.

In a particular embodiment the rubber modified thermoplastic resin is an ASA graft copolymer such as that manufactured and sold by General Electric Company under the trademark GELOY®, and particularly an acrylate-modified acrylonitrile-styrene-acrylate graft copolymer. ASA graft copolymers include, for example, those disclosed in U.S. Pat. No. 3,711,575. ASA graft copolymers also comprise those described in commonly assigned U.S. Pat. Nos. 4,731,414 and 4,831,079. In some embodiments of the invention where an acrylate-modified ASA is used, the ASA component further comprises an additional acrylate-graft formed from monomers selected from the group consisting of C₁ to C₁₂ alkyl- and aryl-(meth)acrylate as part of either the rigid phase, the rubber phase, or both. Such copolymers are referred to as acrylate-modified acrylonitrile-styrene-acrylate graft copolymers, or acrylate-modified ASA. A particular monomer is methyl methacrylate to result in a PMMA-modified ASA (sometimes referred to hereinafter as “MMA-ASA”). The rubber modified thermoplastic resin is present in compositions of the invention in an amount in one embodiment in a range of between about 5 wt. % and about 90 wt. %, in another embodiment in a range of between about 5 wt. % and about 80 wt. %, in another embodiment in a range of between about 10 wt. % and about 70 wt. %, in another embodiment in a range of between about 15 wt. % and about 65 wt. %, in still another embodiment in a range of between about 20 wt. % and about 65 wt. %, in still another embodiment in a range of between about 25 wt. % and about 45 wt. %, and in still another embodiment in a range of between about 30 wt. % and about 40 wt. %, based on the weight of resinous components in the composition.

The rigid thermoplastic phase of the rubber modified thermoplastic resin may be formed solely by polymerization carried out in the presence of rubber substrate, or by addition of one or more separately synthesized rigid thermoplastic polymers to the rubber modified thermoplastic resin comprising the composition, or by a combination of both processes. Compositions of the invention comprise a separately synthesized rigid thermoplastic resinous component comprising structural units derived from a mixture of at least one alkenyl aromatic monomers and at least one monoethylenically unsaturated nitrile monomer. Suitable alkenyl aromatic monomers include, but are not limited to, vinyl aromatic monomers, such as, for example, styrene and substituted styrenes having one or more alkyl, alkoxy, hydroxy or halo substituent groups attached to the aromatic ring, including, but not limited to, alpha-methyl styrene, p-methyl styrene, 3,5-diethylstyrene, 4-n-propylstyrene, 4-isopropylstyrene, vinyl toluene, alpha-methyl vinyl toluene, vinyl xylene, trimethyl styrene, butyl styrene, t-butyl styrene, chlorostyrene, alpha-chlorostyrene, dichlorostyrene, tetrachlorostyrene, bromostyrene, alpha-bromostyrene, dibromostyrene, p-hydroxystyrene, p-acetoxystyrene, methoxystyrene and vinyl-substituted condensed aromatic ring structures, such as, for example, vinyl naphthalene, vinyl anthracene. Substituted styrenes with mixtures of substituents on the aromatic ring are also suitable. As used herein, the term “monoethylenically unsaturated nitrile monomer” means an acyclic compound that includes a single nitrile group and a single site of ethylenic unsaturation per molecule and includes, but is not limited to, acrylonitrile, methacrylonitrile, ethacrylonitrile, alpha-chloroacrylonitrile, alpha-bromoacrylonitrile, and the like. In some embodiments the separately synthesized rigid thermoplastic polymer comprises structural units essentially identical to those of the rigid thermoplastic phase comprising the rubber modified thermoplastic resin. In some particular embodiments the separately synthesized rigid thermoplastic polymer comprises structural units derived from styrene and acrylonitrile; alpha-methylstyrene and acrylonitrile; alpha-methylstyrene, styrene, and acrylonitrile; styrene, acrylonitrile, and methyl methacrylate; alpha-methyl styrene, acrylonitrile, and methyl methacrylate; or alpha-methylstyrene, styrene, acrylonitrile, and methyl methacrylate, or the like or mixtures thereof. Separately synthesized rigid thermoplastic polymer is present in compositions of the invention in an amount in one embodiment in a range of between about 5 wt. % and about 90 wt. %, in another embodiment in a range of between about 5 wt. % and about 80 wt. %, in another embodiment in a range of between about 10 wt. % and about 70 wt. %, in another embodiment in a range of between about 15 wt. % and about 65 wt. %, in still another embodiment in a range of between about 20 wt. % and about 65 wt. %, in still another embodiment in a range of between about 25 wt. % and about 45 wt. %, and in still another embodiment in a range of between about 30 wt. % and about 40 wt. %, based on the weight of resinous components in the composition.

When the separately synthesized rigid thermoplastic resinous component comprises SAN, then the molecular weight of the SAN is not particularly critical. In some embodiments the molecular weight of the SAN corresponds to an intrinsic viscosity in a range of about 40-80 cubic centimeters per gram (cc/g) or in other embodiments to an intrinsic viscosity in a range of about 50-80 cc/g, or in still other embodiments to an intrinsic viscosity in a range of about 50-75 cc/g, or in other embodiments to an intrinsic viscosity in a range of about 50-70 cc/g. Intrinsic viscosity may be determined using standard methods such as ASTM D2857 or ISO 1628 or BS 2782.

Compositions of the invention comprise at least one halogenated flame retardant. In one particular embodiment the halogenated flame retardant is a halogenated aromatic compound which may be epoxy-derived or non-epoxy derived. Halogenated aromatic compounds which are suitable for use comprise in principle all those which are not volatile and are heat-stable during the preparation and processing of compositions in embodiments of the invention. In some embodiments illustrative halogenated aromatic compounds comprise decabromodiphenyl ether, octabromodiphenyl, octabromodiphenyl ether, tribromotetrachlorotoluene, and oligomeric bromine compounds, such as, for example, oligocarbonates based on tetrabromobisphenol A with or without phenolic or halogenated phenolic end capping agents, and also polymeric bromine-containing compounds, such as, but not limited to, high molecular weight polycarbonates based on tetrabromobisphenol A, or nuclear-brominated polyphenylene oxides, or brominated epoxy resins.

Suitable halogenated aromatic compounds also comprise tetrabromobenzene, tetrachlorobenzene, pentabromotoluene, hexachlorobenzene, hexabromobenzene, hexabromobiphenyl, octabromobiphenyl, 2,2′-dichlorobiphenyl, 2,4′-dibromobiphenyl, 2,4′-dichlorobiphenyl, hexabromobiphenyl, triphenylmethane chloride, tetrachlorophthalic acid, tetrachlorophthalic anhydride, tetrabromophthalic acid, tetrabromophthalic anhydride, tribromophenol, tetrabromophenol, as well as additional halogenated aromatic compounds known in the art. Also included are diaromatics of which the following are representative: 2,2-bis(3,5-dichlorophenyl) propane; bis(2-chlorophenyl)methane; bis(2,6-dibromophenyl)methane; 1,1-bis(4-iodophenyl) ethane; 1,2-bis(2,6-dichlorophenyl) ethane; 1,1-bis(2-chloro-4-iodophenyl) ethane; 1,1-bis(2-chloro-4-methylphenyl) ethane; 11-bis(3,5-dichlorophenyl) ethane; 2,2-bis(3-phenyl-4-bromophenyl) ethane; 2,3-bis(4,6-dichloronaphthylpropane; 2,2-bis(2,6-dichlorophenyl) pentane; 2,2-bis(3,5-dichlorophenyl) hexane; bis(4-chlorophenyl) methane; bis(3,5-dichlorophenyl) cyclohexylmethane; bis(3-nitro-4-bromophenyl) methane; bis(4-hydroxy-2,6-dichloro-3-methyloxyphenyl) methane; 2,2-bis(3,5-dichloro-4-hydroxyphenyl) propane; bis (3,5-dibromo-4-hydroxyphenyl) propane; 2,2-bis(3-bromo-4-hydroxyphenyl) propane; 2,2-bis(3,5-dibromo-4-hydroxylphenyl) propane diglycidyl ester; bis(4-(2,3-dibromopropoxy)-3,5-dichlorophenyl) methane, or the like. The preparation of these and other applicable halogenated aromatic compounds are known in the art. In place of the divalent aliphatic group, in the above examples, there may be substituted sulfide, sulfoxy, or the like. For example there may be given, 2,4-dichloro-2′,4′-dibromophenylsulfoxide, bis(2,4-dichlorophenyl) sulfide or the like. Representative examples of halogenated flame retardants are also given in U.S. Pat. Nos. 6,500,889, 6,780,348, and 7,109,260.

Additional suitable halogenated aromatic compounds comprise the halogenated diphenyl ethers. Particular embodiments comprise those halogenated diphenyl ethers containing two to ten halogen atoms, such as decabromodiphenyl ether, octabromodiphenyl ether, hexabromodiphenyl ether, pentabromodiphenyl ether, tetrabromodiphenyl ether, tribromodiphenyl ether, dibromodiphenyl ether, hexachlorodiphenyl ether, pentachlorodiphenyl ether, tetrachlorodiphenyl ether, trichlorodiphenyl ether, dichlorodiphenyl ether and halogenated diphenyl polyalkylene ethers of the formula (I):

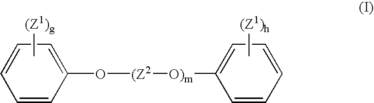

wherein g and h are each independently a whole number of 1-5, particularly 5; m is a whole number of 1-10, particularly 1-3; Z¹ is a halogen, e.g. bromine or chlorine; and Z² is a divalent hydrocarbon radical of 1-6 carbon atoms, particularly 1-4 carbon atoms including methylene, ethylene, propylene, isopropylene, butylene, and the like. Particular diphenyl ethers are for example those containing 6-10 halogens including for instance bis(2,4,6-tribromophenyl) ether and decabromobiphenyl ether.

Additional suitable halogenated aromatic compounds are halogenated phthalimides and halogenated bisphthalimides of the general formulas (II) or (III) or mixtures thereof:

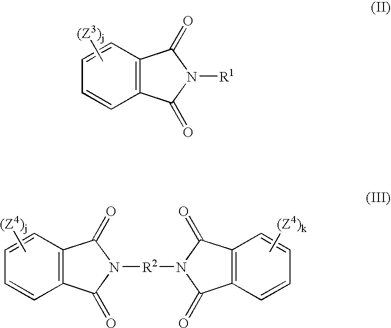

wherein R¹ is a hydrogen atom or a C₁-C₆, particularly C₁ -C₄, alkyl or halogenated alkyl radical or a non-substituted or halogen substituted phenyl or naphthyl radical; R² is a single bond or a divalent radical, Z³ and Z⁴ are a halogen atom, particularly bromine or chlorine, and j and k are each independently a whole number from 1-4, particularly 4. Exemplary of suitable halogenated phthalimides are: dichlorophthalimide, dibromophthalimide, tetrabromophthalimide, tribromophthalimide, tetrachlorophthalimide, trichlorophthalimide, N-methyl-tetrachlorophthalimide, N-ethyltetrachlorophthalimide, N-propyltetrachlorophthalimide, N-isobutyltetrachlorophthalimide, N-phenyltetrachlorophthalimide, N-(4-chloro-phenyl)-tetrachlorophthalimide, N-naphthyltetrachlorophthalimide, N-methyltetrabromophthalimide, N-ethyltetrabromophthalimide, N-butyltetrabromophthalimide, N-phenyltetrabromophthalimide, N-ethyltribromophthalimide, N-butyltribromophthalimide, and the like.

Exemplary suitable halogenated bisphthalimides include for example, bis-tetrabromophthalimide, bis-tetrachlorophthalimide, bis-dibromodichlorophthalimide, bis-dibromophthalimide, bis-toluylbromophthalimide, N,N′-ethylene-di-tetrachlorophthalimide, N,N′-propylene-di-tetrachlorophthalimide, N,N′-butylene-di-tetrachlorophthalimide, N,N′-p-phenylene-di-tetrachlorophthalimide, 4,4′-di-tetrachlorophthalimido-diphenyl, N-(tetrachlorophthalimido)-tetrachlorophthalimide, N,N′-ethylene-di-tetrabromophthalimide, N,N′-propylene-di-tetrabromophthalimide, N,N′-butylene-di-tetrabromophthalimide, N,N′-p-phenylene-di-tetrabromophthalimide, N,N′-di-tetrabromophthalimido-diphenyl, N-(tetrabromophthalimido)-tetrabromophthalimide, N,N′-propylene-di-trichlorophthalimide, N,N′-propylene-di-tribromophthalimide, N,N′-p-phenylene-di-tribromophthalimide, N,N′-di-tribromophthalimido-diphenyl, and the like. Mixtures of different halogenated phthalimide-comprising compounds can also be used.

Suitable halogenated flame retardants also comprise the non-exuding, high and low molecular weight halogenated polymeric and copolymeric flame retardants. Inclusive of this group of flame retardants are the halogenated polystyrenes, especially the aromatically bound di- and tri-bromopolystyrenes; the halogenated polyphenylene ethers, especially the polydibromophenylene ethers; and the halogenated polyacrylates, especially those derived from acrylic or methacrylic acids or esters thereof, particularly the benzylesters thereof, having aromatically bound halogen, e.g. bromine. Illustrative examples of suitable polyacrylate flame retardants comprise poly(pentabromobenzyl acrylate), poly(1,2,4,5-tetrabromoxylylene diacrylate) and tetrabromo-p-xylylene diacrylate-tetrachloro-p-xylylene diacrylate copolymer. Other suitable polymeric flame retardants comprise those derived from, at least in part, halogenated dihydric phenols. These comprise high and low molecular weight polycarbonates and copolycarbonates. The former may be prepared by reacting the halogenated dihydric phenol with a carbonate precursor, e.g. carbonyl bromide or carbonyl chloride and, optionally, other dihydric phenols, glycols and/or dicarboxylic acids.

Additional suitable halogenated flame retardants comprise halogenated epoxy compounds or halogenated compounds derived from epoxy compounds such as, but not limited to, diglycidyl ethers of dihydric phenols which may be prepared by the reaction of one or more halogenated dihydric phenols with an epoxy containing monomer such as epichlorohydrin. Suitable examples of the halogenated divalent phenols that may be employed comprise 2,2-bis(3,5-dibromo-4-hydroxyphenyl) propane, 2,2-bis(3,5-dichloro-4-hydroxyphenyl) propane, bis(3,5-dibromo-4-hydroxyphenyl) methane, bis(3,5-dichloro-4-hydroxyphenyl) methane, 2,2-bis(4-hydroxy-2,3,5,6-tetrabromophenyl) propane, 2,2-bis(4-hydroxy-2,3,5,6-tetrachlorophenyl) propane, or the like. In a particular embodiment the halogenated compound comprises structural units of the formula (IV):

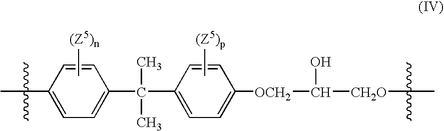

wherein Z⁵ is a halogen atom, particularly bromine or chlorine, and n and p are each independently a whole number from 1-4, particularly 2. In another particular embodiment the halogenated dihydric phenol is 2,2-bis(3,5-dibromo-4-hydroxyphenyl) propane. These polymeric halogenated compounds derived from epoxy compounds may have as terminal groups reactive monomers from which they are derived, e.g. the dihydric phenol, halide or an epoxy group, or, particularly in the case of the lower molecular weight polymers, they may be terminated by the use of chain stoppers which are monofunctional and reactive with the end groups of the repeating units. Suitable chain stoppers will be known to those skilled in the art and include, generally, monohydroxy compounds, e.g., methanol, ethanol, phenol, and the like; monocarboxylic acids or acid halides, among others. Particularly suitable are halogenated, e.g. bromine- or chlorine-containing, chain stoppers as for example the Br₁₋₅ or Cl₁₋₅ substituted phenols, especially tribromophenol.

In one particular embodiment suitable halogenated flame retardants comprise brominated epoxy resins. Suitable brominated epoxy resins comprise those available from Dow Chemical Co. under the tradename D.E.R.™, including, but not limited to, solid resins such as D.E.R.™ 542 and D.E.R.™ 560, and those available from ICL Industrial Products in the product series F-2000 and F-3000.

The molecular weights of polymeric halogenated flame retardant compounds may vary widely and are generally in the range of about 2000 to about 40,000. Particular high molecular weight flame retardant polymers typically have a molecular weight in the range of about 20,000 to about 40,000. Also halogen content may vary widely. Typically the halogen content is from about 20% to greater than 80%, particularly from about 35% to about 70%.

The amount of halogenated flame retardant is typically an effective amount to provide flame retardancy in molded parts of compositions of the invention according to standard test methods. The amount of halogenated flame retardant in a composition of the invention is such that molded parts comprising the composition provide in one embodiment a V-0 rating, in another embodiment a V-1 rating, and in still another embodiment a V-2 rating in the flame resistance test as described in the UL-94 protocol. Compositions of the invention typically comprise less than about 30 wt. % of halogenated flame retardant based on the weight of the entire composition. In other embodiments compositions of the invention comprise an amount of halogenated flame retardant in one embodiment in a range of about 7 wt. % to about 25 wt. %, and in still another embodiment in a range of about 8 wt. % to about 22 wt. %, based on the weight of the entire composition.

Compositions of the invention also comprise at least one antidrip additive. Illustrative antidrip additives comprise one or more fluoropolymers present in an amount that is effective to provide antidrip properties to resinous compositions in embodiments of the invention. Typically, the amount of fluoropolymer present in the compositions is in one embodiment in a range of about 0.01 wt. % and about 2 wt. %, in another embodiment in a range of between about 0.02 wt. % and about 1 wt. %, and in another embodiment in a range of between about 0. 1 wt. % and about 1 wt. %, based on the weight of the entire composition. Suitable fluoropolymers and methods for making such fluoropolymers are known, see, e.g., U.S. Pat. Nos. 3,671,487 and 3,723,373. Suitable fluoropolymers include homopolymers and copolymers that comprise structural units derived from one or more fluorinated alpha-olefin monomers. The term “fluorinated alpha-olefin monomer” means an alpha-olefin monomer that includes at least one fluorine atom substituent. Suitable fluorinated alpha-olefin monomers comprise fluoroethylenes such as, e.g., CF₂═CF₂, CHF═CF₂, CH₂═CF₂, CH₂═CHF, CClF═CF₂, CCl₂═CF₂, CClF═CClF, CHF═CCl₂, CH₂═CClF, and CCl₂═CClF and fluoropropylenes such as, e.g., CF₃CF═CF₂, CF₃CH═CHF, CF₃CH═CF₂, CF₃CH═CH₂, CF₃CF═CHF, CHF₂CH═CHF and CF₃CF═CH₂. In a particular embodiment the fluorinated alpha-olefin monomer is one or more of tetrafluoroethylene (CF₂═CF₂), chlorotrifluoroethylene (CClF═CF₂), vinylidene fluoride (CH₂═CF₂) or hexafluoropropylene (CF₂═CFCF₃)- In various embodiments suitable fluorinated alpha-olefin homopolymers include e.g., poly(tetra-fluoroethylene) and poly(hexafluoroethylene). In other embodiments suitable fluorinated alpha-olefin copolymers comprise those comprising structural units derived from two or more fluorinated alpha-olefin monomers such as, e.g., poly(tetrafluoroethylene-hexafluoroethylene), and those comprising structural units derived from one or more fluorinated monomers and one or more non-fluorinated monoethylenically unsaturated monomers that are copolymerizable with the fluorinated monomers such as, e.g., poly(tetrafluoroethylene-ethylene-propylene) copolymers. Suitable non-fluorinated monoethylenically unsaturated monomers comprise alpha-olefin monomers such as, e.g., ethylene, propylene and butene, acrylate monomers such as e.g., methyl methacrylate and butyl acrylate, vinyl ethers, such as, e.g., cyclohexyl vinyl ether, ethyl vinyl ether and n-butyl vinyl ether, and vinyl esters such as, e.g., vinyl acetate and vinyl versatate. In a particular embodiment the fluoropolymer particles range in size from about 50 nm to about 500 nm as measured by electron microscopy. In a particular embodiment the fluoropolymer is a poly(tetrafluoroethylene) homopolymer (“PTFE”).

Since direct incorporation of a fluoropolymer into a thermoplastic resinous composition tends to be difficult, the fluoropolymer may in one embodiment be preblended in some manner with a second polymer to form a concentrate. In a particular embodiment the fluoropolymer is encapsulated by the second polymer. In one embodiment the second polymer is at least one other resinous component of the composition with which the fluoropolymer is to be blended. In a particular embodiment the second polymer is a thermoplastic resin, such as for example an aromatic polycarbonate resin or a styrene-acrylonitrile resin. For example, an aqueous dispersion of fluoropolymer and a polycarbonate resin may be steam precipitated to form a fluoropolymer concentrate for use as a antidrip additive in thermoplastic resinous compositions, as disclosed in, for example, U.S. Pat. No. 5,521,230, or, alternatively, an aqueous styrene-acrylonitrile resin emulsion, or an aqueous acrylonitrile-butadiene-styrene resin emulsion may be used, wherein, following precipitation, a co-coagulated fluoropolymer-thermoplastic resinous composition is dried to provide a PTFE-thermoplastic resin powder as disclosed in, for example, U.S. Pat. No. 4,579,906. The fluoropolymer additive in the form of fluoropolymer-thermoplastic resin powder comprises in one embodiment from about 10 wt. % to about 90 wt. %, in another embodiment from about 30 wt. % to about 70 wt. %, and in still another embodiment from about 40 wt. % to about 60 wt. % fluoropolymer, and in one embodiment from about 30 wt. % to about 70 wt. %, and in another embodiment from about 40 wt. % to about 60 wt. % of the second polymer. In another embodiment a fluoropolymer additive may be made by emulsion polymerization of one or more monoethylenically unsaturated monomers in the presence of aqueous fluoropolymer dispersion to form a second polymer in the presence of the fluoropolymer. Suitable monoethylenically unsaturated monomers are disclosed above. The emulsion is then precipitated, e.g., by addition of sulfuric acid. The precipitate is dewatered, e.g., by centrifugation, and then dried to form a fluoropolymer additive that comprises fluoropolymer and an associated second polymer. The dry emulsion polymerized fluoropolymer additive is typically in the form of a free-flowing powder. In another embodiment the monoethylenically unsaturated monomers that are emulsion polymerized to form the second polymer comprise one or more monomers selected from vinyl aromatic monomers, monoethylenically unsaturated nitrile monomers and C₁-C₁₂ alkyl (meth)acrylate monomers. Suitable vinyl aromatic monomers, monoethylenically unsaturated nitrile monomers and C₁-C₁₂ alkyl (meth)acrylate monomers are disclosed above. In a particular embodiment the second polymer comprises structural units derived from styrene and acrylonitrile. In another particular embodiment the second polymer comprises from about 60 wt. % to about 90 wt. % structural units derived from styrene and from about 10 wt. % to about 40 wt. % structural units derived from acrylonitrile. The emulsion polymerization reaction mixture may optionally include emulsified or dispersed particles of a third polymer, such as, e.g., an emulsified butadiene rubber latex. The emulsion polymerization reaction may be initiated using a conventional free radical initiator. A chain transfer agent such as, e.g., a C₉-C₁₃ alkyl mercaptan compound such as nonyl mercaptan, t-dodecyl mercaptan or the like, may optionally be added to the reaction vessel during the polymerization reaction to reduce the molecular weight of the second polymer. In one particular embodiment no chain transfer agent is used. In another embodiment the stabilized fluoropolymer dispersion is charged to a reaction vessel and heated with stirring. The initiator system and the one or more monoethylenically unsaturated monomers are then charged to the reaction vessel and heated to polymerize the monomers in the presence of the fluoropolymer particles of the dispersion to thereby form the second polymer. Suitable fluoropolymer additives and emulsion polymerization methods are disclosed, for example, in U.S. Pat. No. 5,804,654. In a particular embodiment, the second polymer exhibits a weight average molecular weight of from about 10,000 to about 200,000 g/mol. relative to polystyrene standards. In one embodiment an encapsulated fluoropolymer comprises poly(tetrafluoroethylene) resin particles having a particle size of about 35 micrometers to about 70 micrometers and particularly having a particle size of about 40 micrometers to about 65 micrometers. Other illustrative examples of antidrip additives are taught in U.S. Pat. Nos. 4,753,994 and 5,102,696, and in European Patent Application No. 899303.

Compositions of the invention may optionally comprise at least one additive which comprises an inorganic or organic antimony compound. Such compounds are widely available or can be made in known ways. In particular embodiments the type of antimony compound used is not critical, the choice being primarily based on economics. For example, as inorganic compounds there can be used antimony oxide, antimony carbonate, antimony trioxide, antimony phosphate, KSb(OH)₆, (NH₄)₂SbF₅, and the like. A wide variety of organic antimony compounds can also be used such as antimony esters with organic acids, cyclic alkyl antimonates, aryl antimonic acids and the like. Illustrative examples of organic antimony compounds comprise potassium antimony tartrate, antimony caproate, Sb(OCH₂CH₃)₃, Sb(OCH(CH₃)CH₂CH₃)₃, sodium antimonate, antimony polymethylene glycolate, polyphenylene antimony, and the like. In particular embodiments antimony compounds comprise antimony oxide, antimony trioxide or sodium antimonate. When present, an additive comprising an antimony compound may be used in compositions of the invention in an amount that is less than that of the halogenated flame retardant. In some embodiments an additive comprising an antimony compound may be used in compositions of the invention in an amount in a range of 0 wt. % to about 15 wt. %, particularly in a range of about 1 wt. % to about 15 wt. %, more particularly in a range of about 2 wt. % to about 10 wt. %, and still more particularly in a range of about 3 wt. % to about 8 wt. %, based on the weight of the entire composition. Furthermore, it is possible to substitute one or more other additives such as but not limited to zinc borate, in total or in part for the antimony compound.

Compositions of the invention may also optionally comprise at least one acid scavenger. In one embodiment the acid scavenger is not dissolved in a solvent for combination with other components of the flame retardant thermoplastic resinous composition. Illustrative examples of acid scavengers include, but are not limited to, a natural or synthetic hydrotalcite, a zinc-substituted hydrotalcite, an amorphous basic aluminum magnesium carbonate, a basic magnesium carbonate, an aluminum hydroxide, a dolomite, a zeolite, and a magnesium hydroxide, or at least one of the products thereof obtained by optionally treating the surfaces with a surface treating agent. Illustrative surface treating agents comprise those known in the art, for example, anionic surfactants, silane coupling agents, titanium coupling agents, fatty acid amides, fatty acid salts, fatty acid esters, and the like. Specific examples thereof include anionic surfactants such as sodium stearate, sodium oleate, sodium laurylbenzenesulfonate, and the like, silane- or titanium-based coupling agents such as vinyl triethoxysilane, gamma-aminopropyltrimethoxysilane, isopropyltriisostearoyl titanate, isopropyltridecylbenzenesulfonyl titanate and the like, and higher fatty acid esters such as glycerin monostearate, glycerin monooleate, and the like. Illustrative examples of acid scavengers include, but are not limited to, those described in U.S. Pat. Nos. 4,427,816, 5,106,898, 5,234,981, 6,500,889, 6,780,348, and 7,109,260. Natural hydrotalcite has been described as having the formula Mg₆Al₂(OH)₁₆CO₃. 4H₂O. A representative empirical formula of a synthetic hydrotalcite is Al₂Mg₄₋₃₅OH₁₁₋₃₆CO₃(_{1.67}).xH₂O. Examples of synthetic hydrotalcites comprise Mg_{0.7}Al₀₋₃(OH)₂(CO₃)₀₋₁₅.0.54H₂O, Mg₄₋₅Al₂(OH)₁₃CO₃.3.5H₂O, and Mg₄₋₂Al(OH)_{12.4}CO₃. Hydrotalcites are commercially available for example from Ciba under the trade designations HYCITE®; from Kyowa Chemical Company under the trade designations ALCAMIZER®, DHT-4A, DHT-4A-2, DHT-4C and DHT-4V; and from J. M. Huber Corporation under the trade designations HYSAFE® 510, HYSAFE® 539, and HYSAFE® 530. In various embodiments an acid scavenger may be used in compositions of the invention in an amount in a range of 0 wt. % to about 5 wt. %, particularly in an amount in a range of about 0.05 wt. % to about 5 wt. %, more particularly in an amount in a range of about 0.08 wt. % to about 4 wt. %, and still more particularly in an amount in a range of about 0.1 wt. % to about 3 wt. % by weight, based on the weight of the entire composition.

Mixtures of at least one additive comprising an antimony compound and at least one acid scavenger may be employed. When employed as a mixture, the combined amount of at least one additive comprising an antimony compound and at least one acid scavenger is in one embodiment less than or equal to about 10 wt. %, in another embodiment less or equal to about 8 wt. %, and in still another embodiment less than or equal to about 6 wt. %, based on the total weight of the composition.

Compositions of the present invention may also optionally comprise additives known in the art including, but not limited to, stabilizers, such as color stabilizers, heat stabilizers, light stabilizers, antioxidants, UV screeners, and UV absorbers; lubricants, flow promoters and other processing aids; plasticizers, antistatic agents, mold release agents, impact modifiers, fillers, and colorants such as dyes and pigments which may be organic, inorganic or organometallic; and like additives. Illustrative additives include, but are not limited to, silica, silicates, zeolites, titanium dioxide, stone powder, glass fibers or spheres, carbon fibers, carbon black, graphite, calcium carbonate, talc, lithopone, zinc oxide, zirconium silicate, iron oxides, diatomaceous earth, calcium carbonate, magnesium oxide, chromic oxide, zirconium oxide, aluminum oxide, crushed quartz, clay, calcined clay, talc, kaolin, asbestos, cellulose, wood flour, cork, cotton and synthetic textile fibers, especially reinforcing fillers such as glass fibers, carbon fibers, metal fibers, and metal flakes, including, but not limited to aluminum flakes. Often more than one additive is included in compositions of the invention, and in some embodiments more than one additive of one type is included. In a particular embodiment a composition further comprises an additive selected from the group consisting of colorants, dyes, pigments, lubricants, stabilizers, heat stabilizers, light stabilizers, antioxidants, UV screeners, UV absorbers, fillers, and mixtures thereof.

The manner of adding one or more halogenated flame retardants to a thermoplastic composition in embodiments of the present invention is not critical. In some embodiments all or a portion of a halogenated flame retardant may be combined in essentially undiluted form with other composition components. In other embodiments all or a portion of a halogenated flame retardant may be pre-combined with at least a portion of one or more resinous polymers to prepare a masterbatch, and then the remaining resinous polymer may be added and mixed therewith later. All or a portion of one or more additives such as an antimony compound or an acid scavenger or both, and/or all or a portion of one or more conventional additives may also optionally be present in any masterbatch. In some embodiments the masterbatch is prepared in an extrusion process. The amount of at least one flame retardant in the masterbatch is in one embodiment in a range of 30-70 wt. %, and in another embodiment in a range of 40-60 wt. %, based on the weight of the masterbatch.

Compositions of the invention and articles made therefrom may be prepared by known thermoplastic processing techniques. Known thermoplastic processing techniques which may be used include, but are not limited to, extrusion, calendering, kneading, profile extrusion, sheet extrusion, coextrusion, molding, extrusion blow molding, thermoforming, injection molding, co-injection molding and rotomolding. The invention further contemplates additional fabrication operations on said articles, such as, but not limited to, in-mold decoration, baking in a paint oven, surface etching, lamination, and/or thermoforming.

Compositions of the present invention are suitable for use in applications that may require high notched Izod impact strength (NII) values in molded parts. Parts molded from compositions of the invention exhibit NII values in one particular embodiment of greater than or equal to about 5 kilojoules per square meter (kJ/m²) and in another particular embodiment of greater than or equal to about 6 kJ/m² as determined according to ISO 180 at room temperature. Compositions of the present invention are also suitable for use in applications that may require high flow in the melt, for example in injection molding applications. In a particular embodiment, compositions of the invention exhibit flow rates in the melt which increase as the molecular weight of a resinous component decreases. In still another particular embodiment, compositions of the invention exhibit flow rates in the melt which increase with decreasing molecular weight of one or more resinous components comprising those with structural units derived from styrene and acrylonitrile; alpha- methylstyrene and acrylonitrile; alpha-methylstyrene, styrene, and acrylonitrile; styrene, acrylonitrile, and methyl methacrylate; alpha-methyl styrene, acrylonitrile, and methyl methacrylate; or alpha-methylstyrene, styrene, acrylonitrile, and methyl methacrylate; or the like or mixtures thereof. In another particular embodiment, compositions of the invention exhibit flow rates in the melt which increase as the molecular weight of a resinous component decreases and also exhibit NII values in molded parts which do not significantly decrease as the molecular weight of a resinous component decreases, wherein the phrase “significantly decrease” means that in one embodiment the NII values do not decrease by more than about 1-2 kJ/m² and more particularly do not decrease by more than about 1 kJ/m². In another particular embodiment, when SAN is present as the separately synthesized rigid thermoplastic resinous component, molded parts of compositions of the invention exhibit NII values which do not decrease by more than about 1-2 kJ/m over a molecular weight range for SAN corresponding to an intrinsic viscosity in a range of about 40-80 cc/g. Still more particularly, compositions of the invention exhibit melt volume rates in one embodiment of greater than or equal to about 11 cubic centimeters per 10 minutes (cm³/10 min.) and in another embodiment of greater than or equal to about 15 cm³/10 min. as determined according to ISO 1133. Still more particularly, compositions of the invention exhibit melt volume rates in one embodiment of greater than or equal to about 11 cubic centimeters per 10 minutes (cm³/10 min.) and in another embodiment of greater than or equal to about 15 cm³/10 min. as determined according to ISO 1133, when the separately synthesized rigid thermoplastic resinous component in the composition comprises SAN, and the molecular weight of the SAN corresponds to an intrinsic viscosity in a range of about 40-80 cc/g or to an intrinsic viscosity in a range of about 50-80 cc/g. In one particular embodiment melt volume rates are determined at 220° C. and 10 kilogram weight. Compositions of the invention may also comprise regrind or reworked resinous components.

The compositions of the present invention can be formed into useful articles. Useful articles comprise those which are employed in flame retardant applications, including but not limited to, articles which are prepared by an injection molding process. In some embodiments the articles comprise unitary articles. In other embodiments a composition of the invention may be used as a layer in a multilayer article. In a particular embodiment a composition of the invention may serve as the top layer of a multilayer article and the other layer or layers may comprise any flame retardant thermoplastic, for example flame retardant ABS (acrylonitrile-butadiene-styrene thermoplastic) or the like. In addition in some embodiments said multilayer article may comprise at least one layer comprising a composition of the invention and at least one tielayer between said layer and another layer. Illustrative articles comprising a composition of the invention comprise electrical enclosures, parts and housing used in heating, ventilating, and air conditioning applications, air filter housings, parts used in telecommunication applications, parts used in lawn and garden applications, electrical components, appliance components and housings, washing machine components and housings, dishwasher components and housings, refrigerator components and housings, network enclosures, parts and housing used in personal protection and alarm systems, parts and housing used in ATM and ticket machine applications, parts and housing used in computer and consumer electronic applications, copier covers, printer covers, server bezels, gas detector parts and enclosures, and the like.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

In the following examples MMA-ASA-1 was a copolymer comprising structural units derived from 28-34 wt. % styrene, 10-15 wt. % acrylonitrile, 10-15 wt. % methyl methacrylate, and about 40-45 wt. % butyl acrylate with broad monomodal rubber particle size distribution; ASA-1 was an acrylonitrile-styrene-acrylate copolymer with structural units derived from about 40-45% butyl acrylate, about 35-40% styrene, and about 15-20% acrylonitrile having broad monomodal rubber particle size distribution; SAN-1 was a copolymer with structural units derived from about 25-30 wt. % styrene and about 70-75 wt. % acrylonitrile and having a molecular weight of about 105,000, a melt volume rate (at 220° C. and 5 kilogram weight) of about 16-21 cm³/10 min., and an intrinsic viscosity in a range of 54-56 cc/g; SAN-2 was a copolymer with structural units derived from about 25-30 wt. % styrene and about 70-75 wt. % acrylonitrile and having a molecular weight of about 130,000, a melt volume rate (at 220° C. and 10 kilogram weight) of about 24-32 cm³/10 min., and an intrinsic viscosity in a range of 63-67 cc/g; SAN-3 was a copolymer with structural units derived from about 30-35 wt. % styrene and about 65-70 wt. % acrylonitrile and having a molecular weight of about 150,000, a melt volume rate (at 220° C. and 10 kilogram weight) of about 5.5-8.5 cm³/10 min., and an intrinsic viscosity in a range of 81-86 cc/g; and FR-1 was a brominated epoxy resin. An antidrip additive was made by copolymerizing styrene and acrylonitrile in the presence of an aqueous dispersion of poly(tetrafluoroethylene) (PTFE) (50 wt. % PTFE, 50 wt. % of a styrene-acrylonitrile copolymer containing 75 wt. % styrene and 25 wt. % acrylonitrile). Flow properties are expressed in terms of melt volume rate determined according to ISO 1133 at 220° C. and 10 kilogram weight. Notched Izod impact strength values were determined according to ISO 180. Flame retardant properties were determined according to the UL-94 protocol. In the following examples the amounts of components are expressed in wt. %.

### EXAMPLES 1-4 AND COMPARATIVE EXAMPLES 1-2

Compositions were compounded from the components shown in Table 1. Each composition contained in addition 5.9 wt. % antimony oxide, 0.2 wt. % hydrotalcite, 0.4 wt. % antidrip additive, 3 parts per hundred parts resinous components (phr; wherein resinous components comprise MMA-ASA-1, ASA-1, SAN, and FR-1) of a mixture of lubricants, stabilizers, and antioxidants, and 2 phr pigment. The compounded material was molded into test parts and the parts were tested for flow properties, notched Izod impact strength, and FR properties. The test results are shown in Table 1.

TABLE 1

| Component | C. Ex. 1 | Ex. 1 | Ex. 2 | C. Ex. 2 | Ex. 3 | Ex. 4 |
|---|---|---|---|---|---|---|
| MMA-ASA-1 | 37.4 | 37.4 | 37.4 | — | — | — |
| ASA-1 | — | — | — | 37.4 | 37.4 | 37.4 |
| FR-1 | 21.0 | 21.0 | 21.0 | 21.0 | 21.0 | 21.0 |
| SAN-1 | — | — | 35.1 | — | — | 35.1 |
| SAN-2 | — | 35.1 | — | — | 35.1 | — |
| SAN-3 | 35.1 | — | — | 35.1 | — | — |
| MVR | 10.5 | 20.9 | 27.0 | 10.3 | 21.4 | 28.9 |
| (cm³/10 min.) | | | | | | |
| NII (kJ/m²) | 6.3 | 6.5 | 6.4 | 6.3 | 6.4 | 6.2 |
| UL-94 rating | V-0 | V-0 | V-0 | V-0 | V-0 | V-0 |

The compositions show that there is an increase in flow properties as the molecular weight of the SAN component decreases. However, it surprising and unexpected that there is no corresponding decrease in impact strength in molded parts as the molecular weight of the SAN component decreases. Instead, the impact strength remains essentially constant. The combination of flame retardance, high flow, and high impact strength make these compositions suitable for many commercial uses.

### EXAMPLES 5-9

Compositions were compounded from the components shown in Table 2. Each composition contained in addition 0.4 wt. % antidrip additive, 0.2 wt. % hydrotalcite, 3 parts per hundred parts resinous components (phr; wherein resinous components comprise MMA-ASA-1, ASA-1, SAN, and FR-1) of a mixture of lubricants, stabilizers, and antioxidants, and 0.5 phr pigment. The compounded material was molded into test parts and the parts were tested for flow properties and notched Izod impact strength. The test results are shown in Table 2.

TABLE 2

| Component | Ex. 5 | Ex. 6 | Ex. 7 | Ex. 8 | Ex. 9 |
|---|---|---|---|---|---|
| MMA-ASA-1 | 37.4 | 37.4 | 37.4 | 37.4 | 37.4 |
| FR-1 | 19.9 | 21.0 | 22.1 | 19.9 | 21.0 |
| SAN-1 | 35.1 | 35.1 | 35.1 | 35.1 | 35.1 |
| antimony | 5.9 | 5.9 | 5.9 | 5.6 | 5.6 |
| oxide | | | | | |
| MVR | 26.8 | 27.4 | 29.5 | 26.7 | 28.6 |
| (cm³/10 min.) | | | | | |
| NII (kJ/m²) | 6.1 | 6.3 | 5.8 | 6.4 | 6.0 |

The compositions show that there is only a slight increase in flow properties as the amount of FR-1 increases while the impact strength in molded parts remains essentially constant (less than about 8% change). The percentage increase in flow properties with increasing amount of FR-1 is much less than the percentage increase in flow properties obtained by decreasing the molecular weight of the SAN component as shown in Examples 1-6.

The fact that compositions of the invention show an increase in flow properties as the molecular weight of the SAN component decreases while showing no corresponding decrease in impact strength in molded parts is an unexpected result. Instead, the impact strength in molded parts remains essentially constant. In contrast, U.S. Pat. No. 6,403,723 teaches resinous compositions comprising ASA and SAN, which compositions show increased flow in the melt but decreased impact strength in molded articles as the intrinsic viscosity, and hence the molecular weight, of the SAN component in the composition decreases.

While the invention has been illustrated and described in typical embodiments, it is not intended to be limited to the details shown, since various modifications and substitutions can be made without departing in any way from the spirit of the present invention. As such, further modifications and equivalents of the invention herein disclosed may occur to persons skilled in the art using no more than routine experimentation, and all such modifications and equivalents are believed to be within the spirit and scope of the invention as defined by the following claims. All Patents and published articles cited herein are incorporated herein by reference.

1. A flame retardant composition comprising (i) 20-65 wt. % of an acrylonitrile-styrene-acrylate graft copolymer (ASA) or acrylate-modified ASA, (ii) 25-45 wt. % of at least one rigid thermoplastic polymer comprising structural units derived from styrene and acrylonitrile; alpha-methylstyrene and acrylonitrile; alpha-methylstyrene, styrene, and acrylonitrile; styrene, acrylonitrile, and methyl methacrylate; alpha-methyl styrene, acrylonitrile, and methyl methacrylate; or alpha-methylstyrene, styrene, acrylonitrile, and methyl methacrylate, or mixtures thereof, (iii) 7-30 wt. % of at least one halogenated flame retardant, (iv) 0.01-2 wt. % of at least one antidrip additive, (v) 0-15 wt. % of at least one additive which comprises an inorganic or organic antimony compound, and (vi) 0-5 wt. % of at least one acid scavenger, wherein wt. % values are based on the weight of components (i)-(vi).

2. The flame retardant composition of claim 1, wherein the rigid thermoplastic polymer (ii) comprises structural units derived from styrene and acrylonitrile and has a molecular weight corresponding to an intrinsic viscosity in a range of about 40-80 cubic centimeters per gram (cc/g).

3. The flame retardant composition of claim 1, wherein the halogenated flame retardant comprises a brominated epoxy resin.

4. The flame retardant composition of claim 1, wherein the antidrip additive comprises poly(tetrafluoroethylene).

5. The flame retardant composition of claim 1, comprising 1-15 wt. % of at least one inorganic or organic antimony compound.

6. The flame retardant composition of claim 1, comprising 0.05-5 wt. % of at least one acid scavenger.

7. The flame retardant composition of claim 6, wherein the acid scavenger is selected from the group consisting of a natural hydrotalcite, a synthetic hydrotalcite, a zinc-substituted hydrotalcite, an amorphous basic aluminum magnesium carbonate, a basic magnesium carbonate, an aluminum hydroxide, a dolomite, a zeolite, a magnesium hydroxide, and at least one of the products thereof obtained by optionally treating the surfaces with a surface treating agent.

8. The flame retardant composition of claim 1, further comprising at least one additive selected from the group consisting of a colorant, dye, pigment, lubricant, stabilizer, heat stabilizer, light stabilizer, antioxidant, UV screener, UV absorber, filler, and mixtures thereof.

9. The flame retardant composition of claim 1, which exhibits at least a V-2 rating in a molded article according to the UL-94 protocol.

10. The flame retardant composition of claim 1, which exhibits a V-0 rating in a molded article according to the UL-94 protocol.

11. The flame retardant composition of claim 1, which exhibits a notched Izod impact strength (NII) value of greater than or equal to about 5 kilojoules per square meter (kJ/m²) in a molded article as determined according to ISO 180 at room temperature.

12. The flame retardant composition of claim 11, wherein the NII value in a molded article decreases by less than about 1-2 kJ/m² as the molecular weight of the rigid thermoplastic polymer (ii) decreases.

13. The flame retardant composition of claim 12, wherein the rigid thermoplastic polymer (ii) comprises structural units derived from styrene and acrylonitrile and has a molecular weight corresponding to an intrinsic viscosity in a range of about 40-80 cubic centimeters per gram (cc/g).

14. The flame retardant composition of claim 1, which exhibits a melt volume rate of greater than or equal to about 11 cubic centimeters per 10 minutes (cm3/10 min.) determined according to ISO 1133 at 220° C. and 10 kilogram weight.

15. An article made from the composition of claim 1.

16. A flame retardant composition comprising (i) 20-65 wt. % of an acrylonitrile-styrene-acrylate graft copolymer (ASA) or acrylate-modified ASA, (ii) 25-45 wt. % of a rigid thermoplastic polymer comprising structural units derived from styrene and acrylonitrile (SAN) having a molecular weight corresponding to an intrinsic viscosity in a range of about 40-80 cc/g, (iii) 7-30 wt. % of a brominated epoxy resin, (iv) 0.01-2 wt. % of at least one antidrip additive comprising poly(tetrafluoroethylene), (v) 1-15 wt. % antimony oxide, and (vi) 0.05-5 wt. % hydrotalcite, wherein wt. % values are based on the weight of components (i)-(vi), wherein the composition exhibits (a) at least a V-1 rating in a molded article according to the UL-94 protocol, (b) a notched Izod impact strength (NII) value of greater than or equal to about 5 kilojoules per square meter (kJ/m²) as determined according to ISO 180 at room temperature, and (c) a melt volume rate of greater than or equal to about 11 cubic centimeters per 10 minutes (cm³/10 min.) determined according to ISO 1133 at 220° C. and 10 kilogram weight.

17. The flame retardant composition of claim 16, wherein the antidrip additive comprises a concentrate comprising 50 wt. % poly(tetrafluoroethylene) and 50 wt. % of a styrene-acrylonitrile copolymer containing 75 wt. % styrene and 25 wt. % acrylonitrile.

18. The flame retardant composition of claim 16, further comprising at least one additive selected from the group consisting of a colorant, dye, pigment, lubricant, stabilizer, heat stabilizer, light stabilizer, antioxidant, UV screener, UV absorber, filler, and mixtures thereof.

19. The flame retardant composition of claim 16, wherein the NII value in a molded article decreases by less than about 1 kJ/m² as the molecular weight of the SAN decreases.

20. An article made from the composition of claim 16.
